(19) United States
(12) Patent Application Publication
(10) Pub. No.: US 2026/0024221 A1
(43) Pub. Date: Jan. 22, 2026

(54) EXTENDED BOUNDING SHAPE REPRESENTATIONS IN ASSOCIATION WITH THREE-DIMENSIONAL OBJECT DETECTION

(71) Applicant: NVIDIA Corporation, Santa Clara, CA (US)

(72) Inventors: Dahjung Chung, San Jose, CA (US); Farzin Aghdasi, East Palo Alto, CA (US); Parthasarathy Sriram, Los Altos Hills, CA (US)

(21) Appl. No.: 18/776,643

(22) Filed: Jul. 18, 2024

(51) Int. Cl. G06T 7/521; G06T 7/73; G06V 10/80; G06V 10/82

(52) U.S. Cl. CPC G06T 7/521; G06T 7/73; G06V 10/806; G06V 10/82

(57) ABSTRACT

In various examples, embodiments are directed to generating extended bounding shape representations corresponding with objects in an environment in an efficient and effective manner. In particular, a bounding shape associated with an object may be represented using various parameters, including position parameters, dimension parameters, and orientation parameters that describe the spatial properties of an object. Advantageously, the orientation parameters include representations or indications of rotation about an x-axis, a y-axis, and a z-axis. Orientation parameters associated with multiple orientations, such as angles of rotations about the x-axis, the y-axis, and the z-axis, facilitate a more comprehensive analysis of an environment, particularly in instances in which sensors, such as a camera and LiDAR, are mounted on a wall or ceiling or in other instances in which rotation angles may exist in association with multiple axes.

### BACKGROUND

Various sensors generate different types of sensor data. Oftentimes, the sensor data complements one another. For instance, LiDAR and camera sensors may provide sensor data that supplement one another in different circumstances for various computer vision tasks. By aggregating or fusing various sensor data, such as LiDAR and camera data, the strengths of both sensors may be leveraged to detect objects more reliably, even in challenging conditions. As one example, an object not visible via a camera (e.g., due to blurriness or water droplets) may be detected using LiDAR data. Accordingly, different types of sensor data may be aggregated or combined to facilitate object detection.

One approach for fusing different types of data, such as LiDAR and camera data, includes a bird's-eye view (BEV) fusion of the different types of data. At a high level, such an approach generates a fused or combined set of features in the form of a bird's-eye view. Upon generating a set of fused BEV features, such features may be used to perform object detection, which includes using the fused BEV features to generate or identify bounding boxes corresponding with objects.

In conventional implementations, LiDAR-camera fused BEV datasets are generally used in the autonomous driving domain. In the autonomous driving environment, a bounding box associated with an object may be represented using location parameters, dimension parameters, and a single rotation parameter (e.g., a rotation about a y-axis) and, as such, represent seven degrees of freedom. In particular, rotation about a single axis is generally used as the autonomous vehicle is perpendicular to the ground surface on which it is moving. As the autonomous vehicle does not move up or down, the other axis rotations are assumed zero and not utilized. By way of example, assume an autonomous vehicle includes multiple cameras positioned around the vehicle (e.g., six or eight cameras) and a LiDAR sensor, positioned on the rooftop of the vehicle, that rotates in all directions horizontally. In such a case, the data from the various cameras and the LiDAR may be fused together for use in performing object detection, in which a single rotation parameter is identified to define a bounding box around an object.

Using such a conventional approach in other environment applications, however, may prevent a bounding box associated with an object from being accurately defined. For example, in cases in which a sensor(s), such as a LiDAR, is mounted on a wall, ceiling, or other structure in an environment (e.g., to monitor the environment), a bounding box defined using multiple degrees of freedom (e.g., seven degrees of freedom) may not adequately represent a particular object. For example, a single rotation parameter cannot capture a full range of possible orientations of objects, which may include combinations of rotations about all three axes. As such, an object's actual orientation may be inaccurately represented, thereby resulting in inaccuracies in performing object analysis, such as collision detection, object manipulation, among other things. In this regard, in cases in which a sensor(s), such as a LiDAR sensor and/or camera, is mounted on a fixed structure (e.g., a smart environment use case), the assumptions of zero degrees of rotation about two axes may not be accurate.

Accordingly, using such a conventional approach that may not accurately reflect an object in various environments may be computationally intensive. In particular, accurately identifying objects, such as three-dimensional objects, in an environment may reduce or eliminate a need for various potential subsequent computations, thereby reducing computing resource utilization. For example, accurate object identification may reduce the performance of subsequent searching or scanning in the environment, the performance of additional post-processing tasks to refine an object's location and boundaries and to perform false positive detection, and/or the like. Accurate object identification may also enable efficient resource allocation (e.g., computer processing can focus on particular regions) and enable enhanced object tracking and prediction.

As such, the conventional approach of generating or identifying a single orientation parameter in association with a bounding box corresponding with an object using fused feature data (e.g., associated with a LiDAR sensor(s) and a camera(s)) may result in unnecessary use of computing resources to perform various data processing, particularly when sensors are mounted to monitor the environment. Performing such additional data processing that may be needed due to inaccurate object detection can reduce efficiency of other processes being executed and reduce overall system efficiency, thereby limiting the ability to efficiently and effectively analyze an environment.

### SUMMARY

Embodiments of the present disclosure relate to efficiently and effectively generating extended bounding shape representations corresponding with three-dimensional objects in an environment. Systems and methods are disclosed that identify multiple orientation parameters in association with a bounding shape for an object, such that nine degrees of freedom may be used to define a bounding shape for the object (e.g., x-position, y-position, z-position, width, height, depth, roll, pitch, and yaw). In this way, an accurate bounding shape representing an object may be used for object tracking, manipulation, navigation, and/or other types of analysis of objects in an environment.

In contrast to conventional systems, in some embodiments, spatial parameters, including multiple orientation parameters, are identified in association with a bounding shape corresponding with an object. In this regard, spatial parameters that correspond with a rotation about an x-axis, a rotation about a y-axis, and a rotation about a z-axis may be identified, via a machine learning model (e.g., an object detection model), based on a feature representation representing features associated with multiple sensors. To generate spatial parameters corresponding with rotations around multiple axes, the object detection model may be trained using a training data set that includes multiple orientation spatial parameters (e.g., roll, pitch, and yaw). In some cases, the spatial parameters used for training, including the ground truth orientation parameters, may be synthetically generated, thereby providing a high-quality and efficiently generated training data set.

### BRIEF DESCRIPTION OF THE DRAWINGS

The present systems and methods for generating extended bounding shape representations corresponding with three-dimensional objects in an environment are described in detail below with reference to the attached drawing figures, wherein:

FIG. 1 is a data flow diagram illustrating an example process for a three-dimensional object detection system, in accordance with some embodiments of the present disclosure;

FIG. 2 is an illustration providing one example implementation for generating a unified feature representation, in accordance with some embodiments of the present disclosure;

FIG. 3 provides one example method for generating bounding shape representations for objects, in accordance with some embodiments of the present disclosure;

FIG. 4 provides another example method for generating bounding shape representations for objects, in accordance with some embodiments of the present disclosure;

FIG. 5 provides another example method for generating bounding shape representations for objects, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods disclosed herein relate to generating enhanced or extended bounding shape representations corresponding with objects in an environment in an efficient and effective manner. In this regard, a bounding shape associated with an object may be represented using various parameters, including multiple orientation parameters, that describe the spatial properties of an object. In particular, such spatial parameters include position parameters, dimension parameters, and orientation parameters associated with a three-dimensional environment. Advantageously, the orientation parameters include representations or indications of rotation about an x-axis, a y-axis, and a z-axis. Orientation parameters associated with multiple orientations, such as angles of rotations about the x-axis, the y-axis, and the z-axis, facilitate a more comprehensive analysis of an environment, particularly in instances in which a sensor(s) is mounted on a pole, a wall, or ceiling or in other instances in which rotation angles may exist in association with multiple axes.

Accurately identifying objects, such as three-dimensional objects, in an environment reduces or eliminates the need for various potential subsequent computations, thereby reducing computing resource utilization. For example, accurate object identification may reduce the performance of subsequent searching or scanning in the environment, the performance of additional post-processing tasks to refine an object's location and boundaries and false positive detection, and/or the like. Accurate object identification may also enable efficient resource allocation (e.g., computer processing can focus on particular regions) and enable enhanced object tracking and prediction.

At a high level, embodiments described herein are directed to generating extended bounding shape representations corresponding with objects in an environment in an efficient and effective manner. In this way, objects are identified or detected in association with an extended set of spatial parameters that indicate positions, dimensions, and orientations associated with a bounding shape for an object and, more specifically, an object captured in a unified feature representation that represents features associated with multiple sensors of different types (e.g., a LiDAR sensor and a camera). Accordingly, multiple orientation parameters are identified for a bounding shape associated with an object to define a first angle of rotation about an x-axis, a second angle of rotation about a y-axis, and a third angle of rotation about a z-axis.

In operation, sensor data may be obtained from various sensors of different types. As described, in some cases, the sensors may be positioned on a wall, ceiling, pole, or other structure in the environment to capture sensor data. In some embodiments, the sensors may be positioned in a fixed or static manner to capture a particular or static environment, while objects may move in the environment. Such a static environment with dynamic objects may include a physical layout that remains fixed (e.g., walls, floors, fixed furniture, and other immovable structures) and provides a consistent or stable reference frame for observing movements therein. Objects that may move within such a static environment include people, vehicles, robots, or other movable items. Such objects may move positions, change orientations, interact with static or other dynamic objects, and/or display other behaviors over time. By way of example only, a LiDAR sensor and a camera may be positioned (e.g., in proximity to one or another) and/or oriented to capture a same or similar portion of the environment. In some cases, the sensors may be positioned on a stationary fixture (e.g., a wall, a ceiling, or a post) to capture an interior or exterior environment.

In accordance with obtaining sensor data, for example from a camera and a LiDAR sensor, a representation of a set of features detected in association with objects in an environment may be generated. As used herein, a feature may refer to any feature that captures or indicates a spatial pattern(s) or boundary(ies) associated with an object(s) in an environment. In some embodiments, a unified representation of features is generated. A unified representation of features, or unified feature representation, generally refers to a representation of features identified in association with multiple sensors, such as different types of sensors. Accordingly, various features from different types of sensors, such as a camera and a LiDAR, can be combined or fused into a single, unified representation of features. A unified feature representation may represent features in any number of perspectives or spaces. In this way, features may be converted to a single perspective or space. For example, in cases in which LiDAR and camera features are to be represented in a unified feature representation, a unified feature representation may be in the form of a bird's-eye view (BEV), also referred to as a top-down view. In this way, features associated with a LiDAR sensor and features associated with a camera may be fused or aggregated in a unified BEV space or perspective to generate a unified feature representation. Generating a unified feature representation in the BEV form enables easier recognition of shapes and orientations. Advantageously, utilizing BEV to generate a unified feature representation maintains both geometric structure from LiDAR features and semantic density from camera features.

The feature representation, or unified feature representation, may be used to detect three-dimensional objects in an environment. In this regard, bounding shapes that correspond with objects in the environment may be identified. A bounding shape (e.g., box or cuboid shape) may be used to define a location of an object within an image or representation of an environment. A bounding shape may be represented via spatial parameters that indicate position, dimensions, and orientation of a bounding shape corresponding with an object in the environment. As such, various spatial parameters are generated or identified in association with bounding shapes for objects. In this way, position parameters, dimension parameters, and orientation parameters may be used to characterize or indicate a bounding shape corresponding with an object. Position parameters may include position parameters associated with an x-coordinate, a y-coordinate, and a z-coordinate. Dimension parameters generally define a physical extent or size of a bounding shape along three axes (length, width, and height). Orientation parameters generally refer to an angle associated with a rotation of a bounding shape about or around an axis. Orientation parameters may include an orientation or rotation angle of a bounding shape defining its rotation around a vertical axis (e.g., y-axis), an orientation or rotation angle of a bounding shape defining its rotation around a horizontal axis (e.g., x-axis), and an orientation or rotation angle of a bounding shape defining its rotation around a depth axis (e.g., z-axis). In some cases, orientation or rotation angle may be represented using sine and cosine components. In particular, orientation, that is rotation about an axis, typically denoted as an angle, may be represented using the sine and cosine of the rotation angle, for instance, to avoid issues with discontinuity and ambiguity. Such an approach is more robust and enables the model to learn orientation in a more continuous manner.

To generate spatial parameters, an object detection model may be used that outputs a set of spatial parameters that describe or indicate an object(s) in a three-dimensional space. In one embodiment, an object detection model may be a deep learning network(s) such as a deep neural network(s) (e.g., a convolutional neural network, such as Faster R-CNN), including various convolutional layers, that processes feature representations (e.g., fused BEV data) to detect a set of spatial parameters that correspond with objects in an environment. The object detection model may take, as input, the feature representation(s), such as a unified feature representation(s) and predict or provide, as output, various spatial parameters associated with bounding boxes associated with objects. In one example, the output is in the form of a tensor that includes such position, dimension, and orientation parameters. In some embodiments, the object detection model, or portion thereof, may predict the sine and cosine component in association with rotations about each axis, thereby predicting two separate components for each orientation degree of freedom. In this way, the object detection model may generate 12 spatial parameters, such as position, dimension, and orientation parameters representing nine degrees of freedom.

To predict or generate spatial parameters representing nine degrees of freedom, the object detection model may be trained using ground truth representations of the nine degrees of freedom. As one example, ground truth spatial parameters may include an x-position label, a y-position label, a z-position label, a length label, a width label, a depth label, an angle of rotation about an x-axis, an angle or rotation about a y-axis, and an angle of rotation about z-axis. As another example, ground truth spatial parameters may include an x-position label, a y-position label, a z-position label, a length label, a width label, a depth label, a sine of angle of rotation about an x-axis, a cosine of angle of rotation about an x-axis, a sine of angle or rotation about a y-axis, a cosine of angle of rotation about a y-axis, a sine of angle of rotation about a z-axis, and a cosine of angle of rotation about a z-axis.

In some embodiments, the ground truth labels are synthetically generated. For example, a simulator or graphics engine may be used to generate artificial and photorealistic images in different environments (e.g., a warehouse) including various objects (e.g., people, robots) therein. Using synthetically generated images, the spatial parameters associated with various objects may be known or pre-defined. In this way, for an object, the position, dimensions, and orientation (including three rotational degrees of freedom) may be known (e.g., via the code that generates the graphic) for a camera image and LiDAR point cloud pair. As such, human annotations for ground truth spatial parameters are avoided.

Upon generating or predicting spatial parameters, one or more post processing operations may be performed to refine, filter, and/or interpret predicted spatial parameters. As one example, orientation parameters represented via sine and cosine components may be converted back to an angle of rotation to represent the orientation of the object (e.g., for each orientation associated with an axis of rotation). In this regard, an axis orientation represented by two components (e.g., sine and cosine of angle of rotation) can be converted or transformed to represent the axis orientation via a single angle that represents magnitude of a rotation about an axis. In this regard, six orientation parameters representing three degrees of freedom initially predicted may be converted to three orientation parameters to represent the bounding shape.

The refined or final spatial parameters may then represent a bounding shape(s) associated with an object(s). In this way, a bounding shape may be represented using output or refined spatial parameters, including representations of nine degrees of freedom (e.g., three position representations, three dimension representations, and three orientation representations). Advantageously, representing bounding shapes in nine degrees of freedom, including three orientation representations associated with three axes in three-dimensional space, provides a more comprehensive and precise description of an object's rotation and orientation and reduces or eliminates ambiguity that may otherwise arise with a more limited representation.

Such representations of bounding shapes may be used in various environments, such as a robotics environment (e.g., robotic arms, drones, and autonomous vehicles). Further representations of bounding shapes associated with objects defined by spatial parameters may be used to precisely localize and analyze the objects in a three-dimensional environment. For example, the spatial parameters may be used for object tracking, collision detection and avoidance, object interaction and manipulation, scene understanding, behavioral analysis, data augmentation, object density estimation, anomaly detection, multimodal integration, etc.

As such, the techniques described herein may be used to identify spatial parameters, including various orientation parameters, representing or defining bounding shapes for objects in an efficient and effective manner. The identified spatial parameters representing nine degrees of freedom may be provided to aid in the performance of one or more operations, for example, related to localizing, tracking, and/or analyzing objects in an environment. Unlike conventional approaches, various embodiments provide a way to enable generation of spatial parameters, including multiple orientation parameters, in association with a unified feature representation (e.g., in a BEV form). Representations of bounding shapes using nine degrees of freedom provides a more accurate representation, thereby allowing for a more computer-resource efficient implementation. For example, fewer searches or environment scans may be performed based on accurate object identification, fewer post-processing tasks to refine an object's location and boundaries and detect false positives may be performed, etc. Further, using synthetically generated data for training may enable a more scalable process and provide quality and consistent data, thereby eliminating variability and errors that may arise from human annotations.

Although the present disclosure may be described with respect to an example static environment with dynamic objects, this is not intended to be limiting. For example, the systems and methods described herein may be used, without limitation, in association with non-autonomous vehicles or machines, semi-autonomous vehicles or machines (e.g., in one or more advanced driver assistance systems [ADAS]), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to a smart environment, this is not intended to be limiting, and the systems and methods described herein may be used in augmented reality, virtual reality, mixed reality, robotics, security and surveillance, autonomous or semi-autonomous machine applications, and/or any other technology spaces where objects detection may be performed.

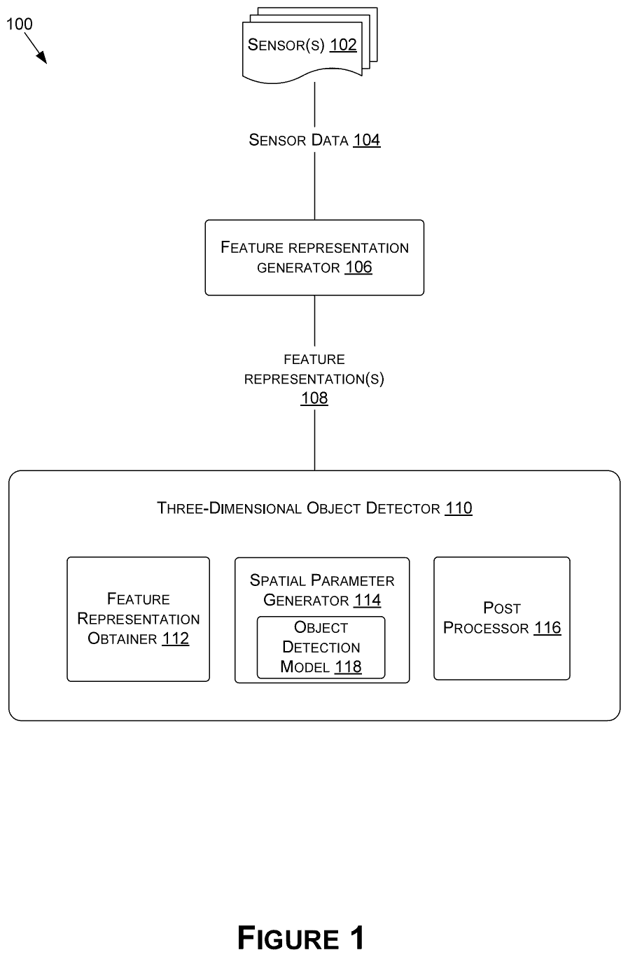

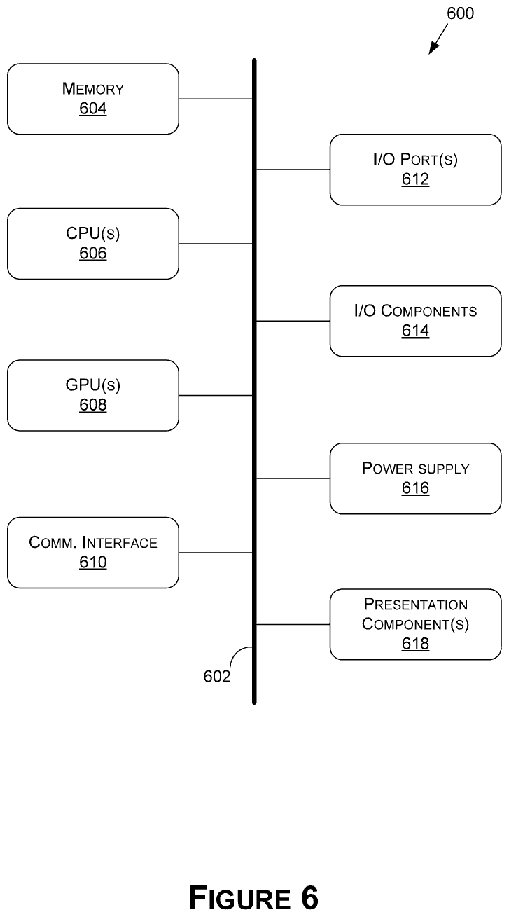

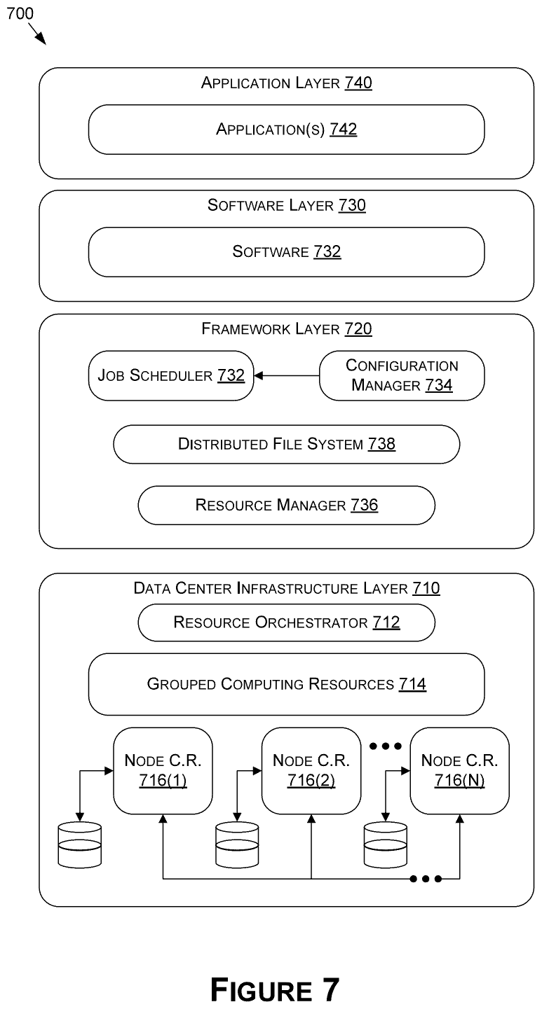

With reference to FIG. 1, FIG. 1 is a data flow diagram illustrating an example process 100 for a three-dimensional object detection system, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 600 of FIG. 6 and/or example data center 700 of FIG. 7.

At a high level, the process 100 uses a three-dimensional object detector 110 to generate representations of three-dimensional objects in an environment. In this regard, the three-dimensional object detector 110 may generate representations of a bounding shape(s) corresponding with an object(s) in an environment. In accordance with embodiments described herein, a bounding shape associated with an object may be represented using various parameters that describe the spatial properties of a detected object. Such spatial parameters include position parameters, dimension parameters, and orientation parameters associated with a three-dimensional environment. Advantageously, the orientation parameters include representations or indications of rotation about an x-axis, a y-axis, and a z-axis. Orientation parameters associated with multiple orientations, such as angles of rotations about the x-axis, the y-axis, and the z-axis, facilitate a more comprehensive analysis of an environment, particularly in instances in which a sensor(s) is mounted on a wall or ceiling or in other instances in which rotation angles may exist in association with multiple axes.

In some embodiments, generating or identifying bounding shape representations may be performed by the three-dimensional object detector 110 using feature representations 108. In this way, the three-dimensional object detector 110 may obtain a feature representation(s) 108 and provide, as output, a corresponding bounding shape representation(s) that represents an object(s) in the environment.

In some embodiments, a feature representation generator 106 is configured to (e.g., programmed to) generate or identify feature representations 108. In particular, the feature representation generator 106 may generate or identify a representation of a set of features detected in association with objects in an environment. As used herein, a feature may refer to any feature that captures or indicates a spatial pattern(s) or boundary(ies) associated with an object(s) in an environment.

In some embodiments, the feature representation generator 106 generates a unified representation of features in an environment. A unified representation of features, or unified feature representation, generally refers to a representation of features identified in association with multiple sensors, such as different types of sensors. In this way, various features from different sensors, or different views, can be combined into a single, unified representation of features. In one embodiment, a unified representation of features represents features associated with a camera (camera features) and features associated with a LiDAR sensor (LiDAR features). In this regard, features identified in association with a camera and features identified in association with a LiDAR sensor may be combined or fused into a unified feature representation that represents features associated with both the camera and LiDAR sensor.

A unified feature representation may represent features in any number of perspectives or spaces. Generally, different features may exist in different views. For example, camera features may be in a perspective view, and LiDAR features may be in a bird's-eye view (BEV). Further, camera features may correspond with distinct viewing angles (e.g., font, back, left, right). Such a view discrepancy may present challenges in generating a unified feature representation as a same element in different feature tensors corresponding to different spatial locations.

As such, to generate a unified feature representation, the feature representation generator 106 may convert features to a single perspective or space. The particular perspective or space to use for the unified feature representation may be selected to be one that reduces or minimizes information loss and that is suitable for different types of tasks. In this regard, in cases in which LiDAR and camera features are to be represented in a unified feature representation, a unified feature representation may be in the form of a bird's-eye view (BEV), also referred to as a top-down view. For instance, features associated with various sensors (e.g., LiDAR and camera) may be fused or aggregated in a unified BEV space or perspective to generate a unified feature representation. In this way, a unified feature representation is constructed in the form of BEV features, integrating data from a camera and LiDAR sensors to provide a comprehensive top-down view of the environment. Generating a unified feature representation in the BEV form enables easier recognition of shapes and orientations. Advantageously, utilizing BEV to generate a unified feature representation maintains both geometric structure from LiDAR features and semantic density from camera features. In particular, the LiDAR-to-BEV projection flattens sparse LiDAR features along the height dimension, thereby preventing geometric distortion, and the camera-to-BEV projection casts each camera feature pixel back into a ray in the three-dimensional space, thereby resulting in a dense BEV feature map that retains full semantic information from the cameras. Further, BEV is generally suitable for various perception tasks as the output space is also in BEV.

To generate a feature representation, such as a unified feature representation, the feature representation generator 106 may obtain and use sensor data 104. Sensor data generally refers to data collected by a sensor(s), such as sensor(s) 102. In some cases, sensor data 104 may be preprocessed such that the data is in a format that may be accepted and processed by the feature representation generator 106. Sensor data 104 may be obtained from any number and any type of sensor(s) 102, such as, without limitation, LiDAR sensors, cameras, and/or other sensor types. For example, the sensor(s) 102 may include a camera and a LiDAR sensor, and the sensor(s) 102 may be used to generate sensor data 104 that represents objects in the 3D environment. In some cases, the sensor data 104 may be collected in association with any number of sensors. For example, a single LiDAR sensor and a single camera may capture sensor data for use in generating a unified feature representation. As another example, a single LiDAR and multiple cameras may be used to capture sensor data for use in generating a unified feature representation.

The sensor(s) 102 may be positioned in the environment in any of a number of ways. As one example, sensor(s) 102 may be positioned or mounted on a wall, ceiling, pole, or any type of structure to capture or collect data from the environment. Each type of sensor may provide different types of data. For example, a LiDAR sensor may provide precise distance measurements, and a camera may provide rich visual details. In some cases, a LiDAR sensor and a camera may be positioned in proximity to one another.

By way of example only, a LiDAR sensor and a camera may be positioned in an environment to capture sensor data. The LiDAR sensor and camera may be positioned (e.g., in proximity to one or another) and/or oriented to capture a same or similar portion of the environment. In some cases, the sensors may be positioned on a wall, a ceiling, or a post to capture an interior or exterior environment. The environment, or portion thereof, being captured may be an environment analyzed, for example, to facilitate a smart city, factory, retail, healthcare, etc. In some cases, the sensors are stationary sensors such that the positioned and/or oriented in a fixed or stationary manner. Although examples provided herein generally describe the sensors as being mounted on a non-ego machine structure, as can be appreciated, in some implementations, one or more of the sensors may be mounted to an ego-machine.

In addition to being aligned or positioned to capture a particular region or area, the sensors 102 may also be aligned, coordinated, or synchronized in time. In this regard, sensors may be aligned to maintain clocks that generate sensor data that is synchronized. For instance, a LiDAR sensor and a camera may be synchronized to capture a space at the same time. By way of example, assume a LiDAR runs at 30 frames per second and a camera runs at 30 frames per second. In such a case, the camera may be slowed down or one of every three images selected to synchronize the space captured. In this way, the sensors, such as a LiDAR and camera, may be synchronized with one another in time and space.

In accordance with obtaining sensor data 104, such as from a LiDAR and a camera, the feature representation generator 106 may project sensor data into a common space or perspective, such as a BEV space. Projecting sensor data into a BEV space may be performed in different manners based on the sensor data. For example, for LiDAR data, LiDAR point clouds may be projected onto a two-dimensional grid representing the ground plan. Such a projection may include converting the three-dimensional coordinates of each point into two-dimensional coordinates (x, y) and accumulating the height (z) or other attributes (e.g., intensity, reflection, etc.) in the grid cells. For camera data, image features may be projected into the BEV space using geometric transformations.

In accordance with the sensor data being projected into a particular or common space, such as a BEV space, features may then be extracted. For instance, a convolutional neural network may be applied to the projected data to extract feature maps. In some cases, the feature extraction process generates multi-channel feature maps where each channel captures different aspects of the sensor data. The extracted features from the different sensors may then be combined to generate a unified feature representation, such as a feature map. Combining the extracted features may be performed in any of a number of ways, such as performing concatenation, using attention mechanisms, using neural network-based fusion techniques, or the like.

A feature representation(s) 108, such as a unified feature representation(s), generated via the feature representation generator 106 may be in any of number of forms. As one example, a feature representation 108 (e.g., a unified feature representation) may be in the form of a feature map, such as a BEV feature map. A feature map generally refers to a representation that encodes various characteristics or features of the input data. Such features may include edges, textures, shapes, and other patterns or data that may be valuable to object detection. A BEV feature map may provide a bird's-eye view of the environment, simplifying the spatial relationships between objects and the ground plan. As described, this perspective may be useful for understanding the layout of objects and their surroundings. In some cases, a BEV feature map includes multiple channels, each representing different types of information, such as height, intensity, velocity, visual features, etc. Channels may also encode features extracted at different levels of abstraction, capturing both low-level details and high-level semantics.

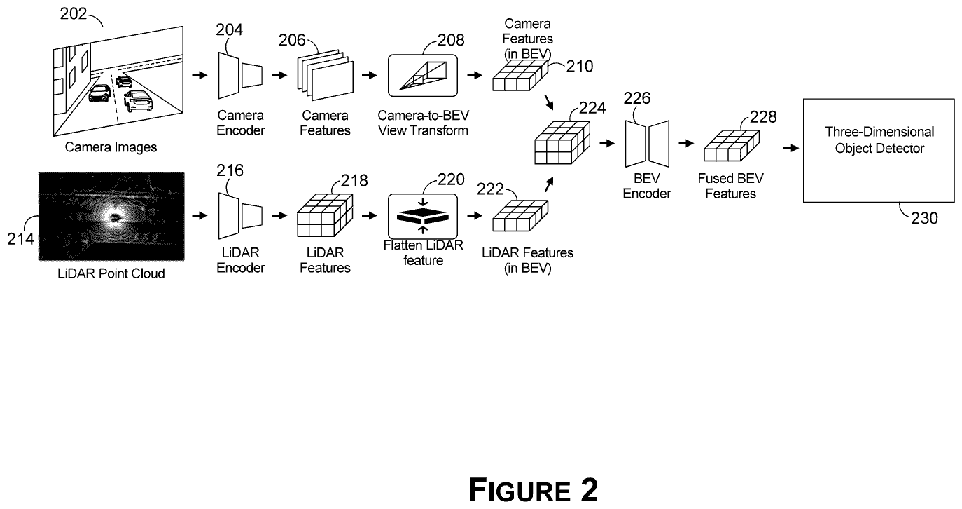

Although a high-level approach in which to generate feature representations 108, such as a unified feature representation, is provided in association with feature representation generator 106, any number of implementations or methods may be used. For instance, FIG. 2, as described in more detail below, provides one example implementation that may be used to generate a unified feature representation, in accordance with embodiments described herein.

Turning to the three-dimensional object detector 110 of FIG. 1, the three-dimensional object detector 110 is generally configured to (e.g., programmed to) detect three-dimensional objects in an environment. In this regard, the three-dimensional object detector 110 identifies bounding shapes that correspond objects in the environment. A bounding shape may be used to define a location of an object within an image or representation of an environment. A bounding shape may be a rectangular, box, or cuboid shape in some examples, but is not limited hereto. As described, a bounding shape may be represented via spatial parameters that indicate position, dimensions, and orientation of a bounding shape corresponding with an object in the environment.

The three-dimensional object detector 110 may include any number of components to perform or execute the functionality described herein. As one example, the three-dimensional object detector 110 may include a feature representation obtainer 112, a spatial parameter generator 114, and a post processor 116.

The feature representation obtainer 112 is generally configured to (e.g., programmed to) obtain feature representations, such as feature representation(s) 108. In accordance with embodiments described herein, the feature representation obtainer 112 obtains unified feature representations. For example, a unified feature representation may represent features associated with a LiDAR sensor and features associated with a camera in a single, cohesive representation, such as a BEV feature map.

The feature representation obtainer 112 may obtain feature representations in any number of ways. For example, in accordance with the feature representation(s) 108 being generated, the feature representation generator 106 may directly provide the generated feature representation(s) 108 to the feature representation obtainer 112. As another example, in accordance with the feature representation(s) 108 being generated, such a feature representation(s) may be stored in a data store for subsequent access. As such, the feature representation obtainer 112 may obtain, access, or retrieve feature representation(s) from such a data store. In such cases, the feature representation(s) may be obtained in a real-time or in a streaming manner, or alternatively, in a batch manner.

The spatial parameter generator 114 is generally configured to (e.g., programmed to) generate spatial parameters. As described herein, spatial parameters generally refer to parameters that describe or indicate spatial properties of an object in the environment. Such spatial parameters include position parameters, dimension parameters, and orientation parameters associated with a three-dimensional environment. In this way, position parameters, dimension parameters, and orientation parameters may be used to characterize or indicate a bounding shape corresponding with an object. Position parameters may include position parameters associated with an x-coordinate, a y-coordinate, and a z-coordinate. Such coordinates may correspond with any portion of a bounding shape, such as a center of a bounding shape. In some cases, position coordinates may represent positions relative to a reference frame (e.g., a position of a sensor).

Dimension parameters generally define a physical extent or size of a bounding shape along three axes (length, width, and height). Dimension parameters may include dimension parameters associated with a length of a bounding shape, a width of abounding shape, and a height of a bounding shape. Such dimensions may be represented using any unit of measurement.

Orientation parameters generally refer to an angle (e.g., roll angle, pitch angle, yaw angle) associated with a rotation of a bounding shape about or around an axis. Orientation parameters may include an orientation or rotation angle of a bounding shape defining its rotation around a vertical axis (e.g., y-axis), an orientation or rotation angle of a bounding shape defining its rotation around a horizontal axis (e.g., x-axis), and an orientation or rotation angle of a bounding shape defining its rotation around a depth axis (e.g., z-axis). The angle, or rotation angle, generally describes a rotation of a bounding shape around a particular axis, indicating which direction the object is facing. These rotation angles may also be referred to as roll angle, pitch angle, and yaw angle. In some cases, an orientation or rotation angle may be represented using sine and cosine components. In particular, orientation, that is rotation about an axis, typically denoted as an angle, may be represented using the sine and cosine of the rotation angle, for instance, to avoid issues with discontinuity and ambiguity. Such an approach is more robust and enables the model to learn orientation in a more continuous manner.

To generate spatial parameters, the spatial parameter generator 114 may use or access an object detection model 118 (or a spatial parameter model) that outputs a set of spatial parameters that describe or indicate an object(s) in a three-dimensional space (e.g., as captured via a sensor(s), such as a camera and LiDAR). An object detection model 118 may be in any number of forms, for instance, that apply or include artificial intelligence (AI) technology. For example, an object detection model 118 may be one or more machine learning models, deep learning models, neural networks, etc. In one embodiment, an object detection model 118 may be a deep neural network(s) (e.g., a convolutional neural network, such as Faster R-CNN), including various convolutional layers, that processes feature representations (e.g., fused BEV data) to detect a set of spatial parameters that correspond with objects in an environment. For example, an object detection model 118 may process input data to proposes candidate regions, refine the spatial parameters, and/or assign confidence scores, resulting in an output (e.g., tensor output) that encapsulates such information for various identified objects.

The spatial parameters output from an object detection model 118 may be in any number of forms. In one example, the output is in the form of a tensor that includes such position, dimension, and orientation parameters. For instance, in cases in which the object detection model 118 detects multiple objects, the output tensor may have a structure or shape as (N, 9) where N is the number of detected objects. In this way, contents of the tensor[i] is reflected as [xᵢ, yᵢ, zᵢ, lᵢ, wᵢ, hᵢ, ψᵢ, θᵢ, and φᵢ] for the i-th detected object. As such, for each detected object i, the tensor contains nine parameter values representing its coordinates (x-center-coordinate, y-center-coordinate, and z-center-coordinate), dimensions (length, width, and height), orientation (yaw angle, pitch angle, and roll angle). As described, in some cases, the yaw, pitch, and roll angles are represented using sine and cosine values. In this way, in such cases in which the spatial parameter model detects multiple objects, the output tensor may have a structure or shape as (N,12), where N is the number of objects. As such, the contents of the tensor[i] is reflected as [xᵢ, yᵢ, zᵢ, lᵢ, wᵢ, hᵢ, sin(ψᵢ), cos(ψᵢ), sin(θᵢ), cos(θᵢ), sin(φᵢ), and cos(φᵢ)], for the i-th detected object. As such, for each detected object i, the tensor includes 12 values representing its center coordinates, dimensions, and orientation (as sine and cosine of the yaw, pitch, and roll angles).

In some cases, the object detection model 118 may also output a confidence score or class probability, which indicates a likelihood that a detected object belongs to a certain class (e.g., a human). Stated differently, the confidence score indicates the spatial parameter model's confidence that the bounding shape contains an object of interest. As such, the confidence score may help filter out low-confidence detections. In some embodiments, a class score may indicate a single class, which may also be referred to as a binary classification, that provides a yes or no indication of the presence of a specific object type (e.g., a person). For instance, for a class of person, a high class score (e.g., near 1) may indicate a high confidence that a person is present in a bounding shape, and a low score (e.g., near 0) may indicate a low confidence or absence of a person. In other embodiments, multiple object classes may be possible. In such a case, the class score may represent probabilities across each of the possible classes. For instance, in a multi-class application including classes of person, vehicle, and animal, class scores associated with a bounding shape may indicate the probability distribution over these three classes. A class with a highest score may be deemed representative of the predicted class for a bounding shape.

As described, to generate spatial parameters in association with objects, an object detection model 118 may take, as input, feature representation(s) 108, such as unified feature representations associated with sensor data captured in association with a sensors (e.g., camera and LiDAR). Based on the input, the spatial parameters, such as a plurality of values (e.g., 12 values) representing coordinates, dimensions, and orientation associated with a bounding shape corresponding with an object, may be provided as output.

In some embodiments, the object detection model 118 generates candidate or proposed regions identified as likely to contain an object(s). In some cases, a region proposal network (RPN) or other similar technology may be used to identify such candidate or proposed regions likely to contain an object(s). To do so, the feature representations (e.g., feature maps) may be fed into the RPN, and the RPN slides over such feature representations to propose regions (or anchors) that may contain an object(s). For instance, a network may slide over a feature map to operate on each spatial location in the feature map. The candidate regions may be identified based on the extracted features that highlight potential object locations. As such, candidate regions, or anchor boxes, may be generated. A candidate region or anchor generally refers to a reference region or box that is used to predict presence and location an object. In some cases, multiple anchor boxes may be generated for each position on the sliding window. Such anchor boxes (or other shapes) may be predefined and of different scales and aspect ratios to cover various object sizes and shapes that may be present.

For the various candidate regions, the RPN may predict an objectness score that measures an extent or likelihood of the candidate region containing an object. The objectness score may facilitate distinguishing between background and potential objects. The RPN may also generate or predict adjustments or offsets to candidate regions (e.g., anchor boxes) to better fit the potential objects. For example, the RPN may predict four coordinates for each anchor box that indicate offsets that will adjust the anchor to better fit the possible object. In some cases, top-scoring candidate regions, or regions with a highest objectness score, may be selected as candidate regions to propose. The number of candidate regions may vary and may be predetermined. In some cases, non-maximum suppression (NMS) is applied to the candidate regions to reduce redundancy of object detection. The spatial parameters associated with the proposed candidate regions generated by the RPN may be designated or deemed as regions that more likely include an object(s).

Upon the RPN generating candidate regions, the candidate regions (e.g., four values representing an anchor box, such as two diagonal corner values or other indications of location and size of candidate regions) may then be provided to a head neural network. As such, the head neural network may obtain, as input, representations of the candidate regions (e.g., in the form of feature maps processed by the RPN). Such feature maps may include summarized information. Using the candidate regions, the head neural network may predict more accurate bounding shape coordinates for each proposal. In this way, the position and size of the bounding shapes may be refined to better fit the detected object. Further, the head neural network may further process the representations of the candidate regions to predict orientation of the object(s).

In more detail, to generate the size, dimensions, and orientation of detected objects, the head neural network may function through a series of layers. In one example, the head neural network uses regions of interest (ROI) pooling or ROI Align to extract feature maps corresponding to each candidate region. Such operations ensure that the features extracted are of a fixed size that can be processed by fully connected layers. For size and dimensions, the head neural network, may perform bounding shape regression. For instance, the head neural network may take, as input, fixed-size feature maps and use fully connected layers to predict the offsets relative to the candidate regions propose by the RPN. Such offsets adjust the size and position of the anchor shapes (e.g., boxes) to tightly fit the detected object. Such a bounding shape regression performs a more refined regression than discussed in relation to the RPN and, in particular, takes the candidate regions from the RPN and predicts new offsets to further adjust the bounding shapes and fine-tunes the candidate regions to closely match the actual object boundaries. The head neural network may use additional context and information from the feature representations, such as feature maps, to make these adjustments more precise. For orientation, the head neural network may use additional regression layers to predict the angle or rotation of the object. Advantageously, the head neural network may predict the sine and cosine component in association with rotations about each axis, thereby predicting two separate components for each orientation degree of freedom. In this way, the head neural network may generate 12 spatial parameters, such as position, dimension, and orientation parameters representing nine degrees of freedom. In some cases, the head neural network may separately perform regression in relation to the various spatial parameters. In other cases, the head neural network may perform combined regression such that size, position, and orientation are concurrently predicted. The various spatial parameters (e.g., 12 spatial parameters) are regressed during the refinement process to obtain a better fitted bounding shape.

In association with the spatial parameter prediction for a bounding shape, a class label may also be determined and/or assigned that indicates a type of object represented with the bounding shape. For example, a bounding shape may be provided with a confidence score that reflects or indicates the likelihood the bounding shape contains an object of a predicted class. In some cases, softmax layers may be used to assign class probabilities.

In some cases, the head neural network may apply non-maximum suppression. For example, NMS may be applied to select a single best bounding shape for each object. For instance, the overlap between bounding shapes may be compared and the ones with the highest overlap may be suppressed.

In this example object detection model 118 described above, the object detection model 118 includes multiple networks, such as the RPN and the head neural network. Such components may be part of a faster R-CNN. In some examples, such networks perform different functions in an object detection pipeline (e.g., RPN generates coarse candidate regions, and the head neural network refines the candidate regions into the final bounding shapes). In implementation, any number of networks may be used. For instance, an object detection model 118 may include an integrated or single-stage approach in which the functionalities performed by the RPN and the head neural network are performed in a single network that can perform both proposal generation and refinement. Although examples are provided herein, the objection detection model 118 is not intended to be limited herein and may be or use any type of technology. By way of example only, an object detection model used to generate spatial parameters may include a Single Shot Multibox Detector (SSD) (e.g., with Inception V2, optimized with TensorRT), You Only Look Once (YOLO), etc.

Further, although the object detection model 118 is provided as separate from the feature representation generator 106, a model may include aspects of both feature representation and object detection as described herein. For instance, a portion of layers of a model may be used to perform feature extraction and another portion of layers of a model may be used to perform object detection.

In some embodiments, the spatial parameter generator 114, or other component, may facilitate training of an object detection model 118. Training an object detection model facilitates generation of suitable spatial features that represent bounding shapes associated with objects. To train an object detection model 118, ground truth spatial parameters are obtained or generated and used for training. Ground truth spatial parameters generally refers to labels or annotations that provide reference data for spatial measurements. In accordance with embodiments described herein, ground truth spatial parameters may include various position, dimension, and orientation parameters. As one example, ground truth spatial parameters may include an x-position label, a y-position label, a z-position label, a length label, a width label, a depth label, an angle of rotation about an x-axis, an angle or rotation about a y-axis, and an angle of rotation about z-axis. As another example, ground truth spatial parameters may include an x-position label, a y-position label, a z-position label, a length label, a width label, a depth label, a sine of angle of rotation about an x-axis, a cosine of angle of rotation about an x-axis, a sine of angle or rotation about a y-axis, a cosine of angle of rotation about a y-axis, a sine of angle of rotation about a z-axis, and a cosine of angle of rotation about a z-axis. As described, such ground truth spatial parameters indicate spatial parameters associated with a bounding shape corresponding with an object. In addition to the ground truth spatial parameters, the ground truth labels or annotations may also include a corresponding class label, for example, that indicates a type or class of an object.

At a high level, the training process uses the ground truth labels to teach the object detection model 118 to generate spatial parameters, including position, dimension, and orientation parameters. In this way, the object detection model 118 may learn to predict a bounding shape for various objects and class associated therewith. For example, a generated unified feature representation may be used to predict position, dimension, and orientation parameters. Such predictions are then compared against the corresponding ground truth labels (e.g., position, dimension, and orientation ground truth labels) to adjust the object detection models parameters and improve its accuracy. In accordance with embodiments described herein, when training or optimizing the object detection model, a loss function is optimized using spatial parameters, including orientation parameters associated with rotation about the x, y, and z axes. In some embodiments, the orientation parameters trained include sine and cosine components. For example, rather than representing an orientation directly using an angle, each orientation parameter (e.g., associated with an axis) may be represented using its sine and cosine components associated with a corresponding angle or rotation about an axis, thereby transforming orientation in association with an axis into two separate values that the model can learn more effectively.

In applying the loss function, an object detection model may be trained to minimize the difference between predicted parameters and corresponding grounding truth labels. In particular, the loss function may measure the difference between the predicted spatial parameters generated by the object detection model and the ground truth spatial parameters, and the object detection model may then use the loss to understand how well the model is performing and to make adjustments to minimize errors. Examples of a loss function that may be used for training include Smooth L1 Loss (Huber Loss), L2 Loss (Mean Squared Error), and Intersection over Union (IoU) Loss, among others.

In some embodiments, the ground truth labels are synthetically generated. For example, a simulator or graphics engine may be used to generate artificial and photorealistic images in different environments (e.g., a warehouse) including various objects (e.g., people) therein. One example of a simulator is NVIDIA ISAAC SIM® of NVIDIA OMNIVERSE® to provide highly realistic and scalable simulation environment for developing, testing, and training robots and autonomous systems, for example. Using synthetically generated images, the spatial parameters associated with various objects may be known or pre-defined. In this way, for an object, the position, dimensions, and orientation (including three rotational degrees of freedom) may be known (e.g., via the code that generates the graphic) for an image and LiDAR point cloud pair. As such, human annotations for ground truth spatial parameters are avoided.

The post processor 116 is generally configured to (e.g., programmed to) refine, filter, and/or interpret results output by the spatial parameter generator 114 or the object detection model 118. In this way, the post processor 116 may apply techniques to the output to refine, filter, and/or interpret the results, thereby transforming the output into meaningful detections that can be used in practical applications. The post processor may perform any number of techniques to perform various tasks.

In accordance with embodiments described herein, the post processor 116 may be configured to (e.g., programmed to) convert sine and cosine components back to an angle of rotation to represent the orientation of the object (e.g., for each orientation associated with an axis of rotation). In this regard, an axis orientation represented by two components (e.g., sine and cosine of angle of rotation) can be converted or transformed to represent the axis orientation via a single angle that represents magnitude of a rotation about an axis. In this regard, six orientation parameters representing three degrees of freedom may be converted to three orientation parameters. In one example, such a conversion technique may be performed using an ‘a tan 2’ function, which computes the angle from the sine and cosine components as follows:

\[\angle=\text{a tan 2}(\ sin(\angle),\ cos(\angle))\]

Additionally or alternatively, the post processor 116 may perform various other tasks. For example, the post processor 116 may remove duplicate detections and retain a best bounding shape for each object. In some examples, non-maximum suppression may be performed to remove duplicate detections. In this regard, for each detected object class, the bounding shapes may be sorted by corresponding confidence scores. The bounding shape with a highest score may be iteratively selected and other bounding shapes with a significant overlap (e.g., using Intersection over Union (IoU) threshold) may be suppressed to remove duplicates.

Further, the post processor 116 may perform bounding shape adjustments to refine the bounding shape spatial parameters. To do so, corrections or adjustments may be applied based on additional heuristics or rules to improve the alignment and accuracy of the bounding boxes.

The post processor 116 may also perform confidence thresholding to filter out low-confidence detections. For example, assume a confidence threshold is established. Any bounding shapes associated with confidence scores below this threshold may be discarded or removed to reduce false positives.

Other post processing techniques or tasks that may be performed by the post processor 116 include, for example, assigning class labels, performing clustering, transforming to global coordinates, perform visualization, and/or temporal smoothing. Assigning class labels to detected objects may be performed by using class scores from the object detection model 118 output to assign a most likely class label to each detected bounding box. Clustering (e.g., for specific applications) may be performed to group multiple detections that belong to the same object. In some embodiments, clustering algorithms (e.g., DBSCAN, Mean Shift) may be applied to group nearby detections into single object representations, particularly useful in dense environments. Transforming to global coordinates is applied to convert local coordinate to global coordinates. For example, if the detections are in the sensor's coordinate frame, they may be transformed to the global coordinate frame using a pose or transformation matrix(s). Performing visualization is generally applied to generate visual representations of the detections for validation and debugging. In some embodiments, visual overlays are created on the original sensor data (e.g., bounding boxes on images, points in 3D space) to help verify the accuracy and performance of the detections. Temporal smoothing may be performed to ensure consistency of detections across frames in data. For instance, temporal smoothing techniques may be applied to reduce jitter and improve the stability of detections over time.

Post-processing in three-dimensional object detection is valuable to refine the raw outputs from the spatial parameter generator 114 and/or object detection model 118. Techniques to perform angle conversion, NMS, bounding shape adjustment, confidence thresholding, and/or class label assignment ensure that the final detections, such as spatial parameters, are accurate and reliable. Techniques to perform clustering, transformation to global coordinates, visualization, temporal smoothing, and/or sensor data aggregation further enhance the quality and applicability of the detections in real-world scenarios. As such, processes that may be performed by the post processor 116 ensure that the three-dimensional object detector 110 performs well and produces results suitable for practical applications such as autonomous driving, robotics, and augmented reality.

In this way, the three-dimensional object detector 110 generates representations of bounding shapes that correspond with objects (e.g., people, machines, etc.). Such bounding shapes may be represented using output or refined spatial parameters, including representations of nine degrees of freedom (e.g., three position representations, three dimension representations, and three orientation representations). Advantageously, representing bounding shapes in nine degrees of freedom, including three orientation representations associated with three axes in three-dimensional space, provides a more comprehensive and precise description of an object's rotation and orientation and reduces or eliminates ambiguity that may otherwise arise with a more limited representation. For example, including orientation parameters for all three axes may ensure even the smallest rotations are accurately captured and represented, which allows for more precise control and manipulation of objects (e.g., in robotics and simulation environments). As another example, using three axes for orientation ensures transformations are consistent and predictable, which may be valuable for tasks such as animation, physics simulations, and navigation. Bound shape representations may also include a class associated with the bounding shape, or object associated therewith.

Such representations of bounding shapes may be used in various environments, including a robotics environment (e.g., robotic arms, drones, and autonomous vehicles). For example, assume robots are navigation inside a warehouse and sensors are distributed around the warehouse. As such, generating or determining representations of bounding shapes in the warehouse may be valuable to monitor various aspects of the warehouse, such as where people or robots are moving. For instance, understanding object positioning and movement may enable path planning for a robot (e.g., to avoid congestion). As another example, such bounding shape representations may be used for traffic monitoring (e.g., monitoring an intersection of a road) or autonomous vehicle navigation.

The representations of the bounding shapes may be used to perform various operations. As one example, bounding shape representations may be used to perform various surveillance and security analysis or operations. For instance, bounding shape representations may be used for intrusion detection (e.g., identify and/or track unauthorized individuals) and/or crowd monitoring (e.g., to prevent overcrowding or enhance crowd control measures). As another example, bounding shape representations may be used to perform various traffic management tasks. For instance, such representations may be used to monitor position and movement of vehicles (e.g., to facilitate real-time traffic management and optimization of traffic lights), perform accident detection, etc. As another example, bounding shape representations may be used to perform robotic navigation or interaction tasks. For instance, such representations may be used to plan efficient collision-free paths for robots, identifying or locating objects a robot may need to move or interact with, etc. Other examples include public safety and emergency response tasks, urban planning and management tasks, environmental monitoring tasks, retail and commercial analysis tasks, AR/VR tasks, among other things.

Turning to FIG. 2, FIG. 2 provides one example implementation that may be used to generate a unified feature representation, in accordance with embodiments described herein. In this example, various features are extracted from multi-modal inputs and converted into a unified feature representation in the form of a shared BEV space (e.g., using view transformations). The unified BEV features may be fused with a fully-convolutional BEV encoder. More specifically, a camera image(s) 202 may be encoded via a camera encoder 204 to extract camera features 206. In this way, the camera encoder 204 (e.g., a neural network or other algorithm) processes the image (e.g., raw image) to produce a set of camera features 206. The camera image may be generated via a camera mounted or positioned in an environment (e.g., affixed to a wall/ceiling/pole/etc.). At block 208, the camera features are transformed into a BEV view to produce a set of camera features in BEV 210. Transforming camera features into a BEV to produce a set of camera features in BEV may include performing techniques that enable the projection of 2D image features onto a 3D plane that simulates a top-down perspective.

With regard to a LiDAR point cloud 214, the LiDAR point cloud 214 may be encoded via a LiDAR encoder 216 to extract LiDAR features 218. In this way, the LiDAR encoder 216 (e.g., neural network or other algorithm) processes the point cloud to produce a set of LiDAR features 218. For instance, a LiDAR encoder 216 may transform a raw point cloud data into a more compact and informative representation. Such a LiDAR point cloud may be generated via a LiDAR mounted or positioned in an environment (e.g., affixed to a wall/ceiling/pole/etc.). At block 220, the LiDAR features are flattened (e.g., along the z-axis) to produce LiDAR features in BEV 222. The camera features in BEV 210 and the LiDAR features in BEV 222 are aggregated, as shown at 224. A BEV encoder 226 performs encoding to generate a set of fused BEV features 228, thereby generating a unified feature representation. Such a set of fused BEV features 228 is provided as a unified feature representation to a three-dimensional object detector 230. In some embodiments, the three-dimensional object detector 230 is similarly configured as the three-dimensional object detector 110.

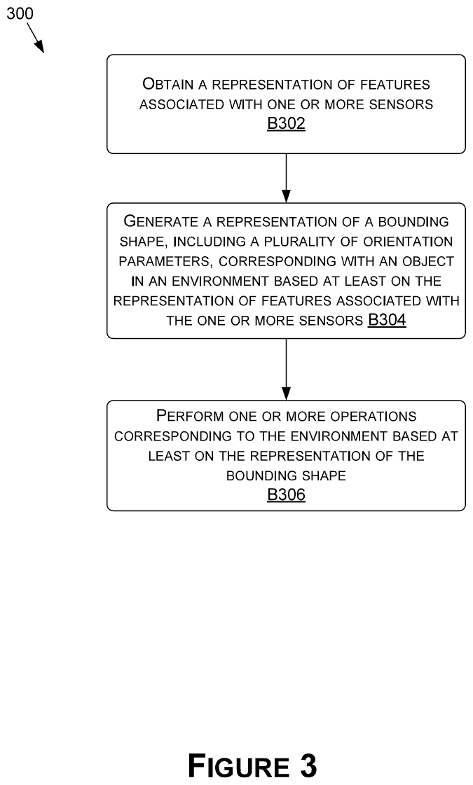

Now referring to FIGS. 3-5, each block of methods 300, 400, and 500, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 300, 400, and 500 may be described, by way of example, with respect to the system of FIG. 1. However, these methods may additionally or alternatively be executed by any one system, or any combination of systems, including, but not limited to, those described herein.

FIG. 3 is a flow diagram showing a method 300 for generating bounding shape representations for objects, in accordance with some embodiments of the present disclosure. The method 300, at block B302, includes obtaining a representation of features associated with one or more sensors. In some embodiments, the representation of features comprises a unified feature representation that aggregates features associated with a LiDAR sensor and features associated with a camera in an environment. The LiDAR sensor and camera may be positioned in various locations. As one example, a camera and a LiDAR sensor are mounted on a fixed structure in an environment (e.g., indoor or outdoor) with limited field of views. Such an environment may be fixed in space and include any number of objects that move dynamically within the space. Objects may also be static and need not move in the space. In some embodiments, a unified feature representation corresponds with a bird's-eye view.

The method 300, at block B304, includes generating a representation of a bounding shape, including a plurality of orientation parameters, corresponding with an object in an environment based at least on the representation of features associated with the one or more sensors. In some cases, the representation of the bounding shape includes an x-coordinate, a y-coordinate, a z-coordinate, a length, a width, a height, a yaw angle, a pitch angle, and a roll angle. In other cases, the representation of the bounding shape comprises an x-coordinate, a y-coordinate, a z-coordinate, a length, a width, a height, a sine of an angle of rotation about an x-axis, a cosine of the angle of rotation about the x-axis, a sine of an angle of rotation about a y-axis, a cosine of the angle of rotation about the y-axis, a sine of an angle of rotation about a z-axis, and a cosine of the angle of rotation about the z-axis.

The representation of the bounding shape may be generated via an object detection model (e.g., object detection model 118). Such an object detection model may be a neural network having one or more layers used to predict multiple orientation parameters associated with the bounding shape. To detect multiple orientation parameters, the object detection model may be trained using synthetic spatial parameters that represent nine degrees of freedom, including orientation associated with an x-axis, orientation associated with a y-axis, and orientation associated with a z-axis. In some cases, a representation of the bounding shape may be generated or identified by predicting, via an object detection model, an initial set of spatial parameters including parameters that represent sine and cosine components of angles of rotation about an x-axis, a y-axis, and a z-axis. Thereafter, a post processor (e.g., post processor 116) may generate the plurality of orientation parameters representing an angle of rotation about the x-axis, an angle of rotation about the y-axis, and an angle of rotation about the z-axis based on the initial set of spatial parameters.

The method 300, at block B306, includes performing one or more operations corresponding to the environment based at least on the representation of the bounding shape. Any operation may be performed including, for example, operations associated with analyzing the environment.

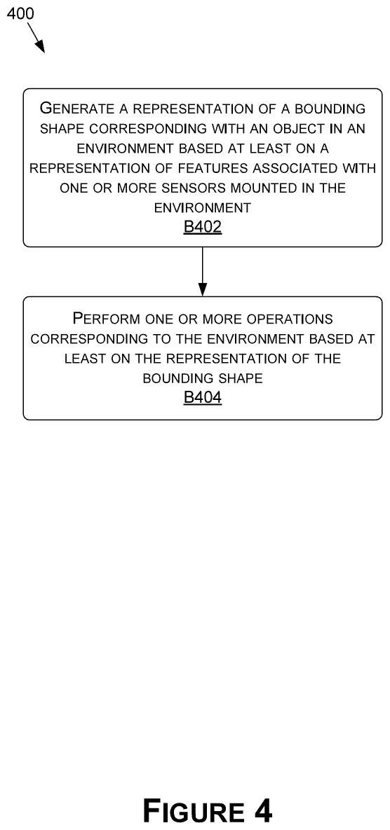

FIG. 4 is a flow diagram showing a method 400 for generating bounding shape representations for objects, in accordance with some embodiments of the present disclosure. The method 400, at block B402, includes generating a representation of a bounding shape corresponding with an object in an environment based at least on a representation of features associated with one or more sensors mounted or positioned in the environment, the representation of the bounding shape including a plurality of orientation parameters. In some embodiments, the environment may include a static background with dynamic objects therein. The representation of features may be in any number of formats, such as a unified representation of features captured by a LiDAR sensor and a camera. In some embodiments, the orientation parameters may include a first parameter indicating a first angle of rotation about a first axis, a second parameter indicating a second angle of rotation about a second axis, and a third parameter indicating a second angle of rotation about a third axis.

The method 400, at block B404, includes performing one or more operations corresponding to the environment based at least on the representation of the bounding shape. Any operation may be performed including, for example, operations associated with analyzing the environment.

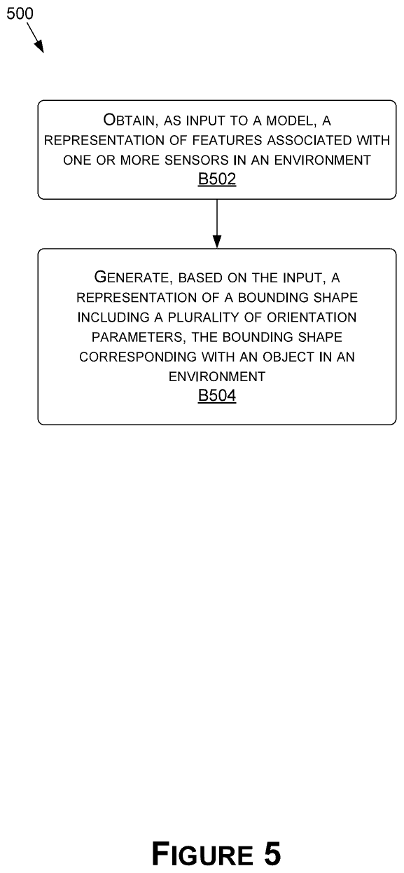

FIG. 5 is a flow diagram showing a method 500 for generating bounding shape representations for objects, in accordance with some embodiments of the present disclosure. The method 500, at block B502, includes obtaining, as input to a model, a representation of features associated with one or more sensors in the environment. In some embodiments, the model may be trained using synthetically generated ground truth orientation parameters associated with an x-axis, a y-axis, and a z-axis.

The method 500, at block B504, includes generating, based on the input, a representation of a bounding shape including a plurality of orientation parameters, the bounding shape corresponding with an object in an environment. In some embodiments, the plurality of orientation parameters may include a first representation of a first angle of rotation about a first axis, a second representation of a second angle of rotation about a second axis, and a third representation of a third angle of rotation about a third axis. In some cases, the representations may be the angles of rotations (e.g., angle of rotation about an x-axis, angle of rotation about a y-axis, and angle of rotation about a z-axis). In other cases, the representations may include the sine and cosine components of the angles of rotations.

The systems and methods described herein may be used by, without limitation, non-autonomous vehicles, semi-autonomous vehicles (e.g., in one or more adaptive driver assistance systems [ADAS]), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray tracing, path tracing, etc.), collaborative content creation for 3D assets, cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems for performing remote operations, systems for performing real-time streaming, systems for generating or presenting one or more of augmented reality content, virtual reality content, or mixed reality content, systems implementing one or more large language models, systems implementing one or more vision language models, systems implementing one or more multi-modal language models; systems for generating synthetic data, systems for generating synthetic data using AI, systems incorporating one or more virtual machines, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 76(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
obtaining a representation of features associated with one or more sensors;
generating a representation of a bounding shape, including a plurality of orientation parameters, corresponding with an object in an environment based at least on the representation of features associated with the one or more sensors; and
performing one or more operations corresponding to the environment based at least on the representation of the bounding shape.

2. The method of claim 1, wherein the representation of features comprises a unified feature representation that aggregates features associated with a LiDAR sensor and features associated with a camera in the environment.

3. The method of claim 1, wherein the representation of features comprises a unified feature representation corresponding with a bird's-eye view of the environment.

4. The method of claim 1, wherein the environment is fixed in space and includes at least one of one or more static objects or one or more dynamic objects that move within the space.

5. The method of claim 1, wherein the representation of the bounding shape comprises an x-coordinate, a y-coordinate, a z-coordinate, a length, a width, a height, a yaw angle, a pitch angle, and a roll angle.

6. The method of claim 1, wherein the representation of the bounding shape comprises an x-coordinate, a y-coordinate, a z-coordinate, a length, a width, a height, a sine of an angle of rotation about an x-axis, a cosine of the angle of rotation about the x-axis, a sine of an angle of rotation about a y-axis, a cosine of the angle of rotation about the y-axis, a sine of an angle of rotation about a z-axis, and a cosine of the angle of rotation about the z-axis.

7. The method of claim 1, wherein the representation of the bounding shape is generated using an object detection model that predicts the representation of the bounding shape based on the representation of features input to the object detection model.

8. The method of claim 1, wherein the representation of the bounding shape is generated using an object detection model comprising a neural network having one or more layers to predict an orientation associated with an x-axis, an orientation associated with a y-axis, and an orientation associated with a z-axis.

9. The method of claim 1, wherein the representation of the bounding shape is generated using an object detection model comprising a neural network trained using synthetic spatial parameters representing nine degrees of freedom, the spatial parameters including an orientation associated with an x-axis, an orientation associated with a y-axis, and an orientation associated with a z-axis.

10. The method of claim 1, wherein the representation of the bounding shape is generated by:
predicting, via an object detection model, an initial set of spatial parameters including parameters that represent sine and cosine components of angles of rotation about an x-axis, a y-axis, and a z-axis; and
generating, via a post processor, the plurality of orientation parameters representing an angle of rotation about the x-axis, an angle of rotation about the y-axis, and an angle of rotation about the z-axis, the plurality of orientation parameters generated based on the initial set of spatial parameters.

11. The method of claim 1, wherein the method is performed using at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system incorporating one or more virtual machines (VMs);
a system implemented at least partially in a data center; or
a system implemented at least partially using cloud computing resources.

12. One or more processors comprising processing circuitry to:
generate a representation of a bounding shape corresponding with an object in an environment based at least on a representation of features associated with one or more sensors positioned in the environment, the representation of the bounding shape including a plurality of orientation parameters; and
perform one or more operations corresponding to the environment based at least on the representation of the bounding shape.

13. The one or more processors of claim 12, wherein the environment comprises a static background with dynamic objects.

14. The one or more processors of claim 12, wherein the representation of the features comprises a unified representation of features captured by a LiDAR sensor and a camera.

15. The one or more processors of claim 12, wherein the plurality of orientation parameters comprise a first parameter indicating a first angle of rotation about a first axis, a second parameter indicating a second angle of rotation about a second axis, and a third parameter indicating a second angle of rotation about a third axis.

16. The one or more processors of claim 12, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system incorporating one or more virtual machines (VMs);
a system implemented at least partially in a data center; or
a system implemented at least partially using cloud computing resources.

17. A system comprising one or more processors to:
obtain, as input to a deep learning model, a representation of features associated with one or more sensors in an environment;
generate, based on the input, a representation of a bounding shape including a plurality of orientation parameters, the bounding shape corresponding with an object in an environment; and
perform one or more operations corresponding to the environment based at least on the representation of the bounding shape.

18. The system of claim 17, wherein the deep learning model is trained using synthetically generated ground truth orientation parameters associated with an x-axis, a y-axis, and a z-axis.

19. The system of claim 17, wherein the plurality of orientation parameters comprise a first representation of a first angle of rotation about a first axis, a second representation of a second angle of rotation about a second axis, and a third representation of a third angle of rotation about a third axis.

20. The system of claim 18, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system incorporating one or more virtual machines (VMs);
a system implemented at least partially in a data center; or
a system implemented at least partially using cloud computing resources.
